(19) United States
(12) Patent Application Publication
(10) Pub. No.: US 2022/0216546 A1
(43) Pub. Date: Jul. 7, 2022

(54) SECONDARY BATTERY

(71) Applicant: MURATA MANUFACTURING CO., LTD., Kyoto (JP)

(72) Inventors: Kazuki HONDA, Kyoto (JP); Yoshiichi HORIKOSHI, Kyoto (JP)

(21) Appl. No.: 17/703,417

(22) Filed: Mar. 24, 2022

Related U.S. Application Data
(63) Continuation of application No. PCT/JP2020/033534, filed on Sep. 4, 2020.

(30) Foreign Application Priority Data
Sep. 30, 2019 (JP) 2019-178790

(51) Int. Cl. H01M 50/109; H01M 50/119; H01M 50/153; H01M 50/159; H01M 50/145

(52) U.S. Cl. CPC H01M 50/109; H01M 50/119; H01M 50/531; H01M 50/159; H01M 50/145; H01M 50/153

(57) ABSTRACT

A secondary battery includes a battery device (100), a first containing member (110), and a second containing member (120). The first containing member (110) has a handleless mug-shaped structure having a first bottom part (111), a first sidewall part (112), and a first opening (110K). The first containing member (110) contains the battery device (100). The second containing member (120) has a handleless mug-shaped structure having a second bottom part (121), a second sidewall part (122), and a second opening (120K). The second containing member (120) is attached to the first containing member (110) in a state in which the second bottom part (121) is opposed to the first opening (110K) and the second sidewall part (122) is pressed against the first sidewall part (112) from an outer side. The second sidewall part (122) includes, in order from a side closer to the second bottom part (121), a first bent part (122B) that is bent toward an inner side and a second bent part (122C) that is bent toward the outer side.

### CROSS REFERENCE TO RELATED APPLICATIONS

The present application is a continuation of PCT application no. PCT/JP2020/033534 filed on Sep. 4, 2020, which claims priority to Japanese patent application no. JP2019-178790 filed on Sep. 30, 2019, the entire contents of which are being incorporated herein by reference.

### BACKGROUND

The present technology relates to a secondary battery.

Various electronic apparatuses such as mobile phones, smartphones, or wearable terminals have been widely used. Accordingly, a secondary battery to be used as a power source in these electronic apparatuses is increasing in importance.

With an increase in performance of electronic apparatuses, for example, a secondary battery having further higher power and capacity has been demanded. Accordingly, various developments have been made on a positive electrode, a negative electrode, a separator, and an electrolytic solution included in the secondary battery, and, in addition thereto, on an outer package that contains an electrode body including the positive electrode, the negative electrode, and the separator.

### SUMMARY

The present disclosure relates to a secondary battery.

Electronic apparatuses, however, are used in a variety of environments. It is thus desirable that an outer package of a secondary battery have high reliability in terms of durability.

Accordingly, it is desirable to provide a secondary battery having higher reliability in terms of durability.

A secondary battery according to an embodiment of the technology includes a battery device, a first containing member, and a second containing member. The first containing member has a handleless mug-shaped structure having a first bottom part, a first sidewall part, and a first opening. The first containing member contains the battery device. The second containing member has a handleless mug-shaped structure having a second bottom part, a second sidewall part, and a second opening. The second containing member is attached to the first containing member in a state in which the second bottom part is opposed to the first opening and the second sidewall part is pressed against the first sidewall part from an outer side. The second sidewall part includes, in order from a side closer to the second bottom part, a first bent part that is bent toward an inner side and a second bent part that is bent toward the outer side.

According to the secondary battery of an embodiment of the technology: the secondary battery includes the first containing member having the handleless mug-shaped structure (the first bottom part, the first sidewall part, and the first opening) and the second containing member having the handleless mug-shaped structure (the second bottom part, the second sidewall part, and the second opening); and the first containing member contains the battery device. The second containing member is attached to the first containing member in a state in which the second bottom part is opposed to the first opening and the second sidewall part is pressed against the first sidewall part from the outer side. The second sidewall part includes, in order from a side closer to the second bottom part, the first bent part that is bent toward the inner side and the second bent part that is bent toward the outer side. Accordingly, it is possible to provide the secondary battery having high reliability in terms of durability.

### BRIEF DESCRIPTION OF THE FIGURES

FIG. 1 is a schematic vertical sectional view of a secondary battery according to embodiment of the technology of the present disclosure, taken along a thickness direction thereof.

FIG. 2 is a sectional view of the secondary battery according to an embodiment, taken along the thickness direction and an enlarged sectional view of a portion in the vicinity of an end of a second sidewall part of a cover member.

FIG. 3 is a vertical sectional view of a secondary battery according to a comparative example, taken along a thickness direction thereof.

FIG. 4 is a graph illustrating temporal variation in single electrode potentials of positive electrodes in can dissolution resistance tests.

### DETAILED DESCRIPTION

One or more embodiments of the technology are described below in detail with reference to the drawings. The following description is a specific example of the technology of the present disclosure, but the technology is not limited to the following example. In addition, arrangement, dimensions, dimensional ratios, etc., of components illustrated in the drawings of the technology are not limited thereto.

It is to be noted that, in this description and the accompanying drawings, components that have substantially the same functional configuration are denoted by the same reference signs, and thus redundant description thereof is omitted.

Described here is a secondary battery having a flat and columnar shape. Examples of the secondary battery include a so-called coin-type secondary battery and a so-called button-type secondary battery. The flat and columnar secondary battery includes a pair of bottom parts and a sidewall part. The bottom parts are opposed to each other. The sidewall part lies between the bottom parts. This secondary battery has a height that is small relative to an outer diameter.

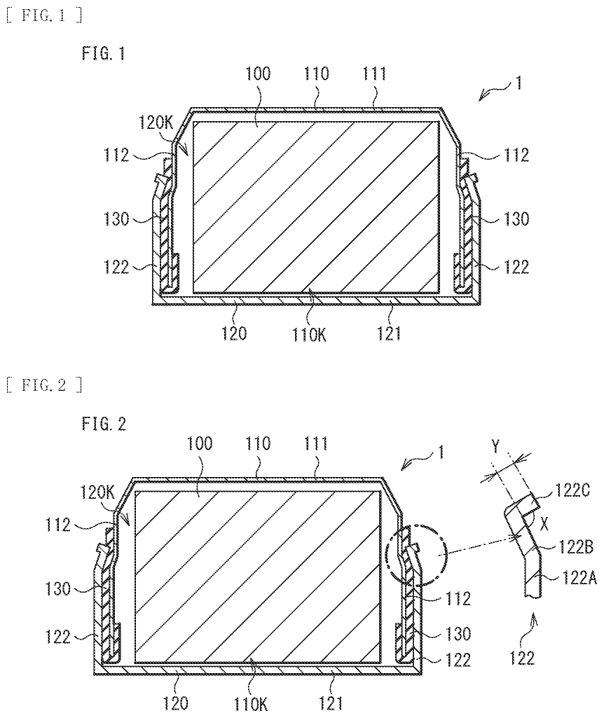

Referring to FIG. 1, a description is given first of a configuration of a secondary battery according to one embodiment of the technology. FIG. 1 is a schematic vertical sectional view of a secondary battery 1, taken along a thickness direction thereof.

As illustrated in FIG. 1, the secondary battery 1 includes a battery device 100, a container member 110, a cover member 120, and a sealing member 130. The secondary battery 1 to be described below is a lithium-ion secondary battery in which charging and discharging are performed by lithium ions moving between a positive electrode and a negative electrode to be described later.

The battery device 100 is a main component of the secondary battery 1 in which charging and discharging reactions take place. Although not specifically illustrated, the battery device 100 is an electrode body in which: a positive electrode and a negative electrode are opposed to each other with a separator interposed therebetween; and the positive electrode, the negative electrode, and the separator are impregnated with an electrolytic solution. The electrode body may be a wound electrode body in which the positive electrode and the negative electrode are wound with the separator interposed therebetween. Alternatively, the electrode body may be a stacked electrode body in which the positive electrode and the negative electrode are stacked on each other with the separator interposed therebetween. Specific configurations of the positive electrode, the negative electrode, the separator, and the electrolytic solution included in the battery device 100 will be described later in “Details of Battery Device”.

The container member 110 has a handleless mug-shaped structure having a first bottom part 111, a first sidewall part 112, and a first opening 110K. The container member 110 contains the battery device 100. The container member 110 serves as a first containing member. Specifically, the container member 110 has a structure in which a lower surface is open, and has a concave sectional shape. A shape of the first bottom part 111 may be a circle, an ellipse, a semicircle or a sector obtained by cutting out a part of a circle, or a polygon.

The cover member 120 has a handleless mug-shaped structure having a second bottom part 121, a second sidewall part 122, and a second opening 120K. The cover member 120 is attached to the container member 110 in a state in which the second bottom part 121 is opposed to the first opening 110K and the second sidewall part 122 is pressed against the first sidewall part 112 from an outer side. The cover member 120 serves as a second containing member. The cover member 120 crimps the first sidewall part 112 by means of the second sidewall part 122, thereby providing a space for containing the battery device 100. In other words, the first sidewall part 112 and the second sidewall part 122 are crimped to each other with the sealing member 130 interposed therebetween. Specifically, the cover member 120 has a structure in which an upper surface is open, and has a concave sectional shape. A shape of the second bottom part 121 is similar to the shape of the first bottom part 111 and is larger than the shape of the first bottom part 111. Thus, the container member 110 and the cover member 120 are fitted to each other while causing the first opening 110K and the second opening 120K to be opposed to each other, which makes it possible to provide a space for containing the battery device 100 inside.

The shape defined by the container member 110 and the cover member 120 is flat and columnar. As described above, the flat and columnar shape includes the pair of bottom parts that are opposed to each other and the sidewall part that lies between the bottom parts, and has the height that is small relative to the outer diameter. Here, the shape defined by the container member 110 and the cover member 120, that is, the shape of the secondary battery as a whole, is flat and cylindrical.

Dimensions of the flat and cylindrical secondary battery are not particularly limited; however, for example, the outer diameter (here, the diameter of the circular shape) is from 3 mm to 30 mm both inclusive, and the height is from 0.5 mm to 70 mm both inclusive. Note that a ratio of the outer diameter to the height, i.e., outer diameter/height, is greater than 1 and smaller than or equal to 25.

One of the container member 110 and the cover member 120 is electrically coupled to the negative electrode of the battery device 100 to serve as a negative electrode terminal, and the other of the container member 110 and the cover member 120 is electrically coupled to the positive electrode of the battery device 100 to serve as a positive electrode terminal. Here, the container member 110 may be electrically coupled to the negative electrode of the battery device 100 to serve as the negative electrode terminal, and the cover member 120 may be electrically coupled to the positive electrode of the battery device 100 to serve as the positive electrode terminal.

The container member 110 and the cover member 120 may each include a Fe—Cr-based or Fe—Cr—Ni-based stainless steel material having satisfactory corrosion resistance. Examples of the Fe—Cr-based or Fe—Cr—Ni-based stainless steel material include a stainless steel material of SUS304, SUS305, or SUS430 in Japanese Industrial Standards (JIS).

However, in the container member 110 or the cover member 120 electrically coupled to the positive electrode having a single electrode potential of the positive electrode of higher than 4.0 V in a charged state, ions such as iron ions, chromium ions, or nickel ions elute from the stainless steel material into the electrolytic solution. This can lower the corrosion resistance. Thus, in the container member 110 or the cover member 120 electrically coupled to the positive electrode, it is preferable that a surface that is opposed to the battery device 100 and is in contact with the electrolytic solution include aluminum which helps to prevent a decrease in corrosion resistance due to a high potential. In other words, it is preferable that the container member 110 or the cover member 120 have a layer including aluminum on an inner side. Specifically, the container member 110 or the cover member 120 electrically coupled to the positive electrode may include a material in which aluminum is stacked or vapor-deposited on one surface of stainless steel, or may include a clad material in which stainless steel and aluminum are joined to each other. Note that an entire part of the container member 110 or the cover member 120 electrically coupled to the positive electrode may include aluminum.

The sealing member 130 is a so-called gasket. The sealing member 130 includes an organic insulator and is interposed between the container member 110 and the cover member 120. The sealing member 130 is able to improve adherence between the container member 110 and the cover member 120 while electrically isolating the container member 110 and the cover member 120 from each other.

Specifically, the sealing member 130 has a ring shape having some thickness. On one side in a thickness direction of the sealing member 130, an end portion of the sealing member 130 is folded toward an inner side to thereby provide a groove. The sealing member 130 fits the first sidewall part 112 of the container member 110 into the groove provided on the one side in the thickness direction, and causes a ring-shaped outer circumference to be closely attached to an inner side of the second sidewall part 122 of the cover member 120. This makes it possible to tightly close an internal space defined by the container member 110 and the cover member 120.

The sealing member 130 may include one or more of organic insulators selected from polyphenylene sulfite, polyether ketone, polyether ether ketone, polyethylene terephthalate, polyarylate, polybutylene terephthalate, and polycyclohexanedimethylene terephthalate.

The second sidewall part 122 of the cover member 120 is double bent. Accordingly, the second sidewall part 122 includes, in order from a side closer to the second bottom part 121, an unbent part 122A, a first bent part 122B, and a second bent part 122C. The unbent part 122A lies along the first sidewall part 112. The first bent part 122B is bent toward the inner side relative to the unbent part 122A. The second bent part 122C is bent toward the outer side relative to the first bent part 122B. The unbent part 122A is disposed closer to the second bottom part 121 than the first bent part 122B is, and the first bent part 122B is disposed closer to the second bottom part 121 than the second bent part 122C is.

In other words, in the cover member 120, a close-to-end portion, i.e., the first bent part 122B, of the second sidewall part 122 is bent toward the inner side, and an end portion, i.e., the second bent part 122C, of the second sidewall part 122 is bent back toward the outer side. The close-to-end portion of the second sidewall part 122 is thus double bent, toward the inner side and toward the outer side in this order. This increases a thickness of a portion contributing to adherence between the cover member 120 and the container member 110, which makes it possible to further increase adhesion strength between the cover member 120 and the container member 110. In addition, the end portion of the second sidewall part 122 serves as a rib structure, which makes it possible to further increase the adhesion strength between the cover member 120 and the container member 110. Therefore, it is possible to suppress leakage of the electrolytic solution from the internal space defined by the container member 110 and the cover member 120, and to improve the reliability in terms of durability.

Referring to FIG. 2, a more detailed description is given of a structure in which the cover member 120 and the container member 110 are crimped to each other. FIG. 2 is a sectional view of the secondary battery 1 taken along the thickness direction and an enlarged sectional view of a portion in the vicinity of an end of the second sidewall part 122 of the cover member 120.

As illustrated in FIG. 2, the second bent part 122C is bent toward the outer side with respect to the first bent part 122B at a bending angle X. The bending angle X may be greater than 45° and less than 135°. Specifically, the bending angle X may be approximately 90°.

The second bent part 122C is bent in such a manner as to protrude from the first bent part 122B toward the outer side by a protrusion length Y. The protrusion length Y may be greater than or equal to 30% of a thickness of the second sidewall part 122. In a case where the thickness of the second sidewall part 122 is 0.15 mm, the protrusion length Y of the second bent part 122C may be 0.05 mm or more.

Bending the second bent part 122C as described above enables provision of an appropriate rib formed utilizing the second sidewall part 122. This makes it possible to further increase the adhesion strength between the container member 110 and the cover member 120.

In addition, the cover member 120 is able to crimp the container member 110 by the first bent part 122B being bent toward the inner side. In this case, the second bent part 122C is bent in such a manner as not to protrude from the unbent part 122A toward the outer side. According to this, it is possible to increase the adhesion strength between the container member 110 and the cover member 120 without increasing a size of an outer shape of the secondary battery 1.

Note that the first sidewall part 112 is bent toward the inner side at a portion where the first bent part 122B is pressed against the first sidewall part 112. Specifically, the first sidewall part 112 is closely attached to the second sidewall part 122 with the sealing member 130 interposed therebetween, and is therefore bent by receiving pressure (i.e., pressed) toward the inner side in accordance with the bending of the first bent part 122B. The first sidewall part 112 is thus double bent, toward the inner side and toward the outer side in this order, as with the second sidewall part 122.

According to the secondary battery 1 having the above-described configuration, the cover member 120 that crimps the container member 110 is double bent. This makes it possible to increase the thickness contributing to the adherence between the container member 110 and the cover member 120. Therefore, it is possible to improve the reliability by increasing the adhesion strength between the container member 110 and the cover member 120.

Next, a specific description is given of a configuration of the battery device 100. Here, the battery device 100 is a wound electrode body in which: the positive electrode and the negative electrode opposed to each other with the separator interposed therebetween are wound; and the positive electrode, the negative electrode, and the separator are impregnated with the electrolytic solution.

The positive electrode includes a positive electrode current collector and a positive electrode active material layer. The positive electrode active material layer is provided on each of both sides of the positive electrode current collector, or only on one side of the positive electrode current collector.

The positive electrode current collector includes one or more of electrically conductive materials including, without limitation, aluminum, nickel, and stainless steel. The positive electrode current collector may have a single-layer structure or a multilayer structure.

The positive electrode active material layer includes one or more of positive electrode active materials into which lithium is insertable and from which lithium is extractable.

The positive electrode active material includes a lithium-containing compound such as a lithium-containing composite oxide or a lithium-containing phosphoric acid compound. The lithium-containing composite oxide is an oxide that includes, as constituent elements, lithium and one or more of other elements. The lithium-containing composite oxide has any of crystal structures including, without limitation, a layered rock-salt crystal structure and a spinel crystal structure. The lithium-containing phosphoric acid compound is a phosphoric acid compound that includes, as constituent elements, lithium and one or more of the other elements. The lithium-containing phosphoric acid compound has a crystal structure such as an olivine crystal structure.

The one or more of other elements described above are one or more of any elements other than lithium. The other elements are preferably those belong to groups 2 to 15 in the long periodic table of elements. The other elements are more preferably one or more of elements including, without limitation, nickel (Ni), cobalt (Co), manganese (Mn), and iron (Fe). Use of the lithium-containing compound including these elements as the positive electrode active material enables the battery device 100 to generate a higher voltage.

Alternatively, the positive electrode active material may be: an oxide such as titanium oxide, vanadium oxide, or manganese dioxide; a disulfide such as titanium disulfide or molybdenum sulfide; a chalcogenide such as niobium selenide; or an electrically conductive polymer such as sulfur, polyaniline, or polythiophene.

The positive electrode active material layer may further include a binding material, an electrically conductive material, or both.

The binding material may include one or more of materials including: a synthetic rubber such as a styrene-butadiene-based rubber, a fluorine-based rubber, or an ethylene propylene diene synthetic rubber; and a polymer compound such as polyvinylidene difluoride or polyimide.

The electrically conductive material may include one or more of carbon materials including, without limitation, graphite, carbon black, acetylene black, and Ketjen black. Alternatively, the electrically conductive material may be a material such as a metal material or an electrically conductive polymer.

The negative electrode includes a negative electrode current collector and a negative electrode active material layer. The negative electrode active material layer is provided on each of both sides of the negative electrode current collector, or only on one side of the negative electrode current collector.

The negative electrode current collector includes one or more of electrically conductive materials including, without limitation, copper, aluminum, nickel, and stainless steel. The negative electrode current collector may have a single-layer structure or a multilayer structure.

The negative electrode active material layer includes one or more of negative electrode active materials into which lithium is insertable and from which lithium is extractable.

The negative electrode active material is a carbon material, a metal-based material, or a mixture of a carbon material and a metal-based material.

Examples of the carbon material include graphitizable carbon, non-graphitizable carbon, and graphite. More specific examples of the carbon material include pyrolytic carbons, cokes, glassy carbon fibers, an organic polymer compound fired body, activated carbon, carbon blacks, low crystalline carbon, and amorphous carbon. Examples of a shape of the carbon material include a fibrous shape, a spherical shape, a particulate shape, and a scale-like shape.

The metal-based material is a material including, as a constituent element or constituent elements, any one or more of metal elements or metalloid elements. The metal-based material may be a simple substance, an alloy, or a compound, and may be a mixture of two or more of these. The metal-based material may include, in addition to a material including two or more metal elements, a material including one or more of metal elements and one or more of metalloid elements. Further, the metal-based material may include one or more of non-metallic elements as a constituent element or constituent elements. The metal-based material has a state such as a solid solution, a eutectic (a eutectic mixture), an intermetallic compound, or a state including two or more thereof that coexist.

Specifically, the metal element or the metalloid element included in the metal-based material is an element that is able to form an alloy with lithium. Examples of the metal element or the metalloid element included in the metal-based material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt).

The negative electrode active material layer may further include a binding material, an electrically conductive material, or both. As the binding material, a material similar to the binding material which may be included in the positive electrode active material layer is employable. As the electrically conductive material, a material similar to the electrically conductive material which may be included in the positive electrode active material layer is employable.

The separator is interposed between the positive electrode and the negative electrode. The separator allows lithium ions to pass therethrough while preventing a short circuit due to contact between the positive electrode and the negative electrode. The separator includes a porous film including, without limitation, a synthetic resin such as polytetrafluoroethylene, polypropylene, or polyethylene, or ceramics. The separator may be a single-layer film, or may be a stacked multilayer film in which two or more porous films are stacked.

On one side or on each of both sides of the porous film of the separator described above, a polymer compound layer may be further provided. The polymer compound layer is able to improve the adherence between the separator and the positive electrode or between the separator and the negative electrode, thereby suppressing a decomposition reaction of the electrolytic solution and the leakage of the electrolytic solution. The polymer compound layer may include one or more of polymer compounds (such as polyvinylidene difluoride) each having high physical strength and high scientific stability. Further, the polymer compound layer may include one or more kinds of inorganic particles of materials including, without limitation, aluminum oxide and aluminum nitride, to improve safety.

The electrolytic solution includes a solvent and an electrolyte salt. The wound electrode body in which the positive electrode and the negative electrode are wound is impregnated with the electrolytic solution.

The solvent includes one or more of non-aqueous solvents including, without limitation, an organic solvent. The electrolytic solution including the non-aqueous solvent is also referred to as a non-aqueous electrolytic solution.

The non-aqueous solvent includes a carbonic acid ester, a chain carboxylic acid ester, a lactone, or a nitrile compound.

The carbonic acid ester includes both a cyclic carbonic acid ester and a chain carbonic acid ester. Examples of the cyclic carbonic acid ester include ethylene carbonate, propylene carbonate, and butylene carbonate. Examples of the chain carbonic acid ester include dimethyl carbonate, diethyl carbonate, ethylmethyl carbonate, and methylpropyl carbonate. Examples of the chain carboxylic acid ester include methyl acetate, ethyl acetate, methyl propionate, ethyl propionate, propyl propionate, methyl butyrate, methyl isobutyrate, methyl trimethylacetate, and ethyl trimethylacetate. Examples of the lactone include γ-butyrolactone and γ-valerolactone. Examples of the nitrile compound include acetonitrile, methoxy acetonitrile, and 3-methoxy propionitrile.

The non-aqueous solvent may further include a material such as 1,2-dimethoxy ethane, tetrahydrofuran, 2-methyltetrahydrofuran, tetrahydropyran, 1,3-dioxolane, 4-methyl-1,3-dioxolane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and dimethylsulfoxide.

In order to improve chemical stability of the electrolytic solution, the non-aqueous solvent may still further include, as an additive or additives, any one or more of an unsaturated cyclic carbonic acid ester, a halogenated carbonic acid ester, a sulfonic acid ester, an acid anhydride, a dinitrile compound, a diisocyanate compound, and a phosphoric acid ester.

The electrolyte salt includes one or more of salts including, without limitation, a lithium salt. However, it goes without saying that the electrolyte salt may include a salt such as a light metal salt other than the lithium salt.

Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr).

Note that the respective materials of the positive electrode, the negative electrode, the separator, and the electrolytic solution included in the secondary battery 1 are not limited to the examples described above, and other materials are also employable.

Next, a description is given of a method of manufacturing the secondary battery 1. It is possible to manufacture the secondary battery 1 by manufacturing the positive electrode and the negative electrode, and thereafter assembling the secondary battery 1, in accordance with a procedure to be described below.

First, the positive electrode active material is mixed with the binding material and the electrically conductive material on an as-needed basis to thereby obtain a positive electrode mixture. Thereafter, the positive electrode mixture is dispersed or dissolved into water or an organic solvent to thereby prepare a paste positive electrode mixture slurry. Thereafter, the positive electrode mixture slurry is applied on both sides of the positive electrode current collector, following which the applied positive electrode mixture slurry is dried to thereby form the positive electrode active material layers on the positive electrode current collector. Thereafter, the positive electrode active material layers may be compression-molded by means of a machine such as a roll pressing machine. The compression-molding may be performed while heating the positive electrode active material layers. The positive electrode active material layers may be compression-molded a plurality of times.

The negative electrode active material layers are formed on both sides of the negative electrode current collector by a method similar to the method of manufacturing the positive electrode described above. Specifically, first, the negative electrode active material is mixed with the binding material and the electrically conductive material on an as-needed basis to thereby obtain a negative electrode mixture. Thereafter, the negative electrode mixture is dispersed or dissolved into water or an organic solvent to thereby prepare a paste negative electrode mixture slurry. Thereafter, the negative electrode mixture slurry is applied on both sides of the negative electrode current collector, following which the applied negative electrode mixture slurry is dried to thereby form the negative electrode active material layers on the negative electrode current collector. Thereafter, the negative electrode active material layers may be compression-molded by means of a machine such as a roll pressing machine. The compression-molding may be performed while heating the negative electrode active material layers. The negative electrode active material layers may be compression-molded a plurality of times.

First, a positive electrode lead is coupled to the positive electrode current collector by a method such as a welding method, and a negative electrode lead is coupled to the negative electrode current collector by a method such as a welding method. Thereafter, the positive electrode and the negative electrode are placed to oppose each other with the separator interposed therebetween, following which the positive electrode, the negative electrode, and the separator are wound to thereby form a wound electrode body. Note that a center pin may be disposed in a space provided at a winding center of the wound electrode body.

Thereafter, the electrode body is placed inside the container member 110. At this time, the negative electrode lead is electrically coupled to the container member 110 by a method such as a welding method. Thereafter, the electrolytic solution is injected into the container member 110 to thereby impregnate the electrode body with the electrolytic solution. This causes each of the positive electrode, the negative electrode, and the separator to be impregnated with the electrolytic solution to thereby form the battery device 100.

In this case, the electrolytic solution is injected into the container member 110 before the cover member 120 crimps the container member 110. The container member 110 or the cover member 120 thus does not have to have a liquid injection hole. Accordingly, it is possible to simplify the configuration of the container member 110 or the cover member 120 because the liquid injection hole is unnecessary. Further, because the electrolytic solution is injected into the container member 110 through the opening having an opening area larger than that of the liquid injection hole, it is possible to improve efficiency of injection of the electrolytic solution for the electrode body, and to simplify the process of injecting the electrolytic solution.

Thereafter, the cover member 120 in which the second bent part 122C of the second sidewall part 122 is bent toward the outer side is placed on the first opening 110K of the container member 110 in such a manner as to be overlapped with the first sidewall part 112 from the outer side with the sealing member 130 interposed therebetween. At this time, the positive electrode lead is electrically coupled to the cover member 120 by a method such as a welding method. Further, the first bent part 122B of the second sidewall part 122 is bent toward the inner side to cause the cover member 120 to crimp the container member 110. The space between the container member 110 and the cover member 120 is thus tightly closed. This makes it possible to seal the internal space defined by the container member 110 and the cover member 120. The secondary battery 1 is manufacturable by the process described above.

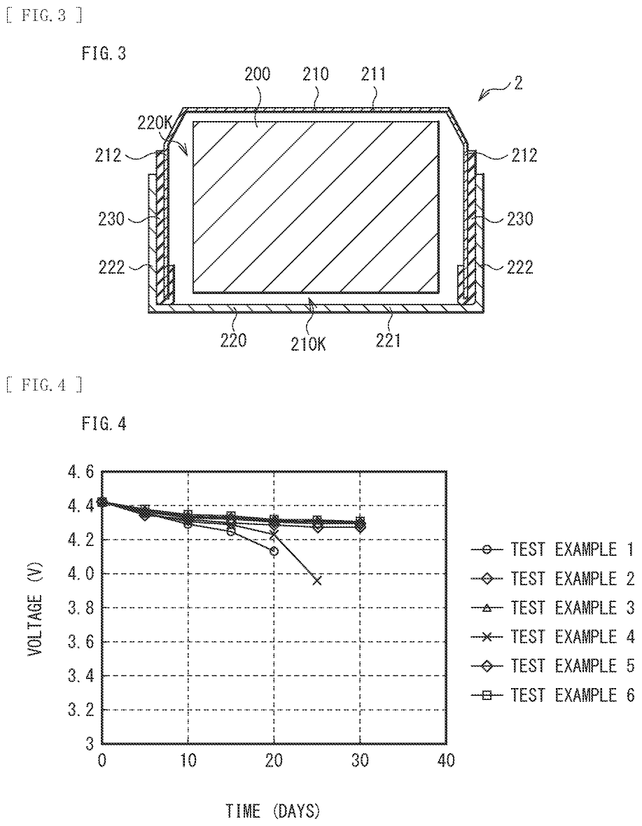

Referring to a secondary battery according to a comparative example illustrated in FIG. 3, a description is given of action and effects of the secondary battery 1 according to the present embodiment. FIG. 3 is a vertical sectional view of a secondary battery 2 according to the comparative example, taken along a thickness direction thereof.

As illustrated in FIG. 3, the secondary battery 2 according to the comparative example includes a battery device 200, a container member 210 (a first bottom part 211, a first sidewall part 212, and a first opening 210K), a cover member 220 (a second bottom part 221, a second sidewall part 222, and a second opening 220K), and a sealing member 230, respectively corresponding to the battery device 100, the container member 110 (the first bottom part 111, the first sidewall part 112, and the first opening 110K), the cover member 120 (the second bottom part 121, the second sidewall part 122, and the second opening 120K), and the sealing member 130 included in the secondary battery 1 according to the present embodiment.

The secondary battery 2 according to the comparative example differs from the secondary battery 1 according to the present embodiment in that the first sidewall part 212 and the second sidewall part 222 are each not bent toward the inner side and that an end portion of the second sidewall part 222 is not bent toward the outer side. In other words, in the secondary battery 2 according to the comparative example, the first sidewall part 212 and the second sidewall part 222 each extend in a straight line in a direction substantially perpendicular to the first bottom part 211 and the second bottom part 221 of the respective handleless mug-shaped structures.

In the secondary battery 1 according to the present embodiment, the second sidewall part 122 is double bent to crimp the container member 110. This makes it possible to increase the thickness contributing to the adherence between the container member 110 and the cover member 120 in an in-plane direction of a cover surface (i.e., a bottom surface of the handleless mug-shaped structure) of the cover member 120. Further, the second bent part 122C serves as the rib structure, which makes it possible to increase the strength of the second bent part 122C. This makes it possible to increase the adhesion strength between the container member 110 and the cover member 120 as compared with the secondary battery 2 according to the comparative example. It is thus possible to further suppress leakage of the electrolytic solution, for example. Therefore, it is possible to provide higher reliability in terms of durability.

Further, the secondary battery 1 according to the present embodiment is able to increase the adhesion strength between the container member 110 and the cover member 120. This makes it possible to change a material included in the container member 110 or the cover member 120 to a material in which a characteristic other than reliability is emphasized.

For example, it is possible to further reduce a thickness of the material included in the container member 110 or the cover member 120, in order to further increase the internal space defined by the container member 110 and the cover member 120. Further, it is possible to employ, as the material included in the container member 110 or the cover member 120, a material (e.g., aluminum) in which corrosion resistance to the electrolytic solution is emphasized at a greater level. As described above, in particular, a force of joining owing to crimping between the container member 110 and the cover member 120 in a case where the container member 110 or the cover member 120 includes a material such as aluminum or a clad material including aluminum tends to be smaller than a force of joining owing to crimping between the container member 110 and the cover member 120 in a case where the container member 110 or the cover member 120 includes another metal material such as SUS. Accordingly, employment of the structure of the present embodiment makes it possible to produce the secondary battery in which the durability is increased and the corrosion resistance is also increased.

### Examples

Referring to test examples, a more detailed description is given below of the secondary battery according to the present embodiment. Note that the following test examples are examples for indicating feasibility and effects of the secondary battery according to the present embodiment, and the technology is not limited to the following test examples.

Secondary batteries according to the test examples were each manufactured by the manufacturing method described above using a positive electrode, a negative electrode, a separator, and an electrolytic solution to be employed in a common lithium-ion secondary battery.

The container member and the cover member each included one of: stainless steel; a clad material including stainless steel and aluminum; and aluminum. The respective thicknesses of the container member and the cover member were each set to 0.15 mm. Note that, in a case where the container member and the cover member each included the clad material including stainless steel and aluminum, an aluminum layer was formed on each of the respective inner sides (i.e., sides to be opposed to the battery device impregnated with the electrolytic solution) of the container member and the cover member. A thickness of the sealing member was set to 0.2 mm.

In each of the secondary batteries according to the test examples 4 to 6, the second bent part was bent at approximately 90° toward the outer side in such a manner that the second bent part protruded toward the outer side by 0.05 mm. In each of the secondary batteries according to the test examples 4 to 6, the second sidewall part (the first bent part) was bent toward the inner side in such a manner that the second bent part did not protrude from the unbent part toward the outer side. Note that such a structure of the secondary battery according to the present embodiment is referred to as “structure 1” in Table 1 below.

In contrast, in each of the secondary batteries according to the test examples 1 to 3, the first sidewall part and the second sidewall part were crimped to each other in such a manner that the second sidewall part extended in a straight line. Note that such a structure of the secondary battery according to the comparative example is referred to as “structure 2” in Table 1 below.

The reliability and the corrosion resistance in terms of durability of each of the secondary batteries according to the test examples 1 to 6 were evaluated by conducting a leakage resistance test and a can dissolution resistance test.

In the leakage resistance test, a state of each of the secondary batteries according to the test examples 1 to 6 after being left to stand in a severe environment at a temperature of 45° C. and a humidity of 93% (relative humidity) for 20 days was observed visually, for example, and the reliability was evaluated on the basis of a definition of leakage according to IEC60086-3 standard. The results are described in Table 1 below. The reliability evaluation described in Table 1 is set on the basis of the definition of leakage according to IEC60086-3 standard, and is higher in the order of “C2”, “C1”, “S3”, “S2”, and “S1”.

In the can dissolution resistance test, the corrosion resistance was evaluated by leaving each of the secondary batteries according to the test examples 1 to 6 having been charged to have the single electrode potential of the positive electrode of 4.4 V to stand in a severe environment at a temperature of 60° C. and a humidity of 90% (relative humidity) for 30 days, and evaluating temporal variation in the single electrode potentials of the positive electrodes. The results are described in Table 1 and FIG. 4. FIG. 4 is a graph illustrating temporal variation in single electrode potentials of the positive electrodes in the can dissolution resistance tests. In the corrosion resistance evaluation described in Table 1, the secondary battery in which the single electrode potential of the positive electrode was 4.2 V or higher after 30 days was evaluated as “A”, and the secondary battery in which the single electrode potential of the positive electrode was lower than 4.2 V within 30 days was evaluated as “B”. As an evaluation result of the corrosion resistance, “A” is more satisfactory than “B”.

TABLE 1

| | | | | Corrosion |
|---|---|---|---|---|
| | Structure | Material | Reliability | resistance |
| Test example 1 | Structure 2 | Stainless steel | S3 | B |
| Test example 2 | Structure 2 | Clad material | C1 | A |
| | | of stainless steel | | |
| | | and aluminum | | |
| Test example 3 | Structure 2 | Aluminum | C2 | A |
| Test example 4 | Structure 1 | Stainless steel | S2 | B |
| Test example 5 | Structure 1 | Clad material | S3 | A |
| | | of stainless steel | | |
| | | and aluminum | | |
| Test example 6 | Structure 1 | Aluminum | S3 | A |

As described in Table 1, comparing with each other test examples in which the cover member and the container member each included the same material, it was apparent that the test examples 4 to 6 corresponding to the secondary batteries according to the present embodiment were improved in the leakage resistance as compared with the test examples 1 to 3, and were thus improved in the reliability in terms of durability of the secondary battery.

Comparing with each other test examples having the same structure, it was apparent that the test examples in which the cover member and the container member each included aluminum or the clad material of stainless steel and aluminum were improved in the corrosion resistance as compared with the test examples in which the cover member and the container member each included stainless steel. Accordingly, it is understood that forming of the aluminum layer on the surface opposed to the battery device impregnated with the electrolytic solution makes it possible to suppress the corrosion, due to the electrolytic solution, of each of the cover member and the container member. According to this, the secondary battery of the present embodiment having the configuration corresponding to the test example 5 or 6 makes it possible to achieve both the reliability such as the leakage resistance and the corrosion resistance with respect to the electrolytic solution, and is thus able to provide higher reliability in terms of durability.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device;
a first containing member that
has a handleless mug-shaped structure having a first bottom part, a first sidewall part, and a first opening, and
contains the battery device; and
a second containing member that
has a handleless mug-shaped structure having a second bottom part, a second sidewall part, and a second opening, and
is attached to the first containing member in a state in which the second bottom part is opposed to the first opening and the second sidewall part is pressed against the first sidewall part from an outer side,
wherein the second sidewall part includes, in order from a side closer to the second bottom part, a first bent part that is bent toward an inner side and a second bent part that is bent toward the outer side.

2. The secondary battery according to claim 1, wherein
the second sidewall part further includes an unbent part that is disposed closer to the second bottom part than the first bent part is, and lies along the first sidewall part, and
the second bent part is bent in a manner that the second bent part does not protrude from the unbent part toward the outer side.

3. The secondary battery according to claim 1, wherein the first sidewall part is bent toward the inner side at a portion where the first bent part is pressed against the first sidewall part.

4. The secondary battery according to claim 1, wherein
the battery device includes a positive electrode and a negative electrode,
the second containing member is electrically coupled to the positive electrode, and
the first containing member is electrically coupled to the negative electrode.

5. The secondary battery according to claim 1, wherein the second containing member includes a layer including aluminum on the inner side.

6. The secondary battery according to claim 1, wherein the first containing member includes stainless steel.

7. The secondary battery according to claim 1, wherein the second bent part is bent toward the outer side with respect to the first bent part at an angle of greater than 45 degrees and less than 135 degrees.

8. The secondary battery according to claim 1, wherein the second bent part is bent toward the outer side with respect to the first bent part in a manner that the second bent part has a length greater than or equal to 30 percent of a thickness of the second sidewall part.

9. The secondary battery according to claim 1, wherein a shape defined by the first containing member and the second containing member is flat and columnar.
